(19) United States
(12) Patent Application Publication
(10) Pub. No.: US 2026/0253566 A1
(43) Pub. Date: Aug. 27, 2026

(54) FORMULATION AND METHOD OF MAKING A ROSIN FORMULATION FOR STRING INSTRUMENTS

(71) Applicant: Upton Bass String Instrument Co., Mystic, CT (US)

(72) Inventor: Gary Upton, Niantic, CT (US)

(21) Appl. No.: 19/545,348

(22) Filed: Feb. 20, 2026

Related U.S. Application Data
(60) Provisional application No. 63/761,661, filed on Feb. 21, 2025.

(51) Int. Cl. G10D 3/16; C09D 7/63; C09D 193/04

(52) U.S. Cl. CPC G10D 3/16; C09D 7/63; C09D 193/04

(57) ABSTRACT

A rosin system for a stringed instrument bow may include a first rosin formulation including at least one base rosin and a second rosin formulation including at least one topcoat rosin. The first rosin formulation may be formulated for forming a rosin base coat layer adhered to a bow string. The second rosin formulation may be formulated for forming a rosin topcoat layer adhered to the rosin base coat layer. The stringed instrument bow including the rosin system having a layered base coat and topcoat may provide enhanced playability for the stringed instrument.

### CROSS-REFERENCE TO RELATED APPLICATIONS

This application claims the benefit of U.S. Provisional Patent Application No. 63/761,661 filed Feb. 21, 2025, the entire contents of which are incorporated by reference herein.

### BACKGROUND OF THE DISCLOSURE

This disclosure is generally directed to rosins, rosin formulations, and rosin systems for a bowed string instrument. A bowed string instrument is a string instrument or chordophone played using a bow that is drawn across the strings. Applying rosin to the bow is a necessity for bowing, i.e., drawing the bow across the strings. Stringed instrument bows are well known and include bow strings (103 (FIG. 1)) made from a variety of materials such as animal hair or synthetic string materials. The bow strings in particular are the bow portion to which rosin is applied and which contact the instrument strings as the bow is drawn across the strings. An unrosined bow will not grab the string and therefore will not cause the movement and vibration of the string responsible for the string’s sound. This disclosure is directed more specifically to rosins and complementary rosin formulations and rosin systems for enhancing playability with respect to a double bass, also known as an upright bass, acoustic bass or simply “the bass”, although the disclosure is not limited thereto. This disclosure is also directed to rosins and complementary rosin formulations and rosin systems for satisfying musician’s preferences based on various sensory properties.

Rosin is a solid form of resin, a sticky substance that is obtained from trees and resembles sap. Typically, rosin is formed by distilling the resin to remove turpentine that occurs naturally in the resin. The rosin is the residue remaining from the distillation process. Another name for rosin is “colophony”. The term “colophony” is, loosely speaking, a more technical term than “rosin” although it is well understood that they refer to the same material. Exemplary trees from which resin may be extracted for processing into rosin include trees in the Pinaceae family, such as pine, fir, and cedar, or other conifers such as spruce and larch. The rosins formed from respective resins of different trees may have unique qualities or properties based on the type of tree and resin. For example, rosins from different tree species may have different colors, textures, smells, and physical properties—among other things—to varying degrees.

Accordingly, different rosins variously affect performance characteristics when applied to a bow and used with a bowed string instrument. Performance characteristics include, without limitation, the musical tone produced by the strings and also the feel and response of the strings for the musician while playing. Similarly, individual rosin formulations—i.e., rosin products containing two or more rosins and potentially other additives—have particular qualities and physical properties that affect performance characteristics. In addition, rosin systems—i.e., combinations of rosins and/or rosin formulations applied to the bow in particular amounts, orders, manners, etc.—will also have particular qualities and properties that affect performance characteristics. The exemplary embodiments according to this disclosure include rosins, rosin formulations, and rosin systems both individually and taken together.

In addition to the playability and other practical or musical characteristics that rosin products affect, many musicians associate their preferred rosin product—or generally a high-quality rosin product—with sensory properties such as color, smell, and tackiness of the rosin product. Accordingly, providing respective rosin products with consistently recognizable sensory properties may be important to a musician looking to replenish or select a rosin product based on sensory properties, whether consciously or passively.

In addition to the qualities and properties of a rosin product, musicians may also be wary of rosin products having chemical fillers with adverse environmental impacts and other undesirable qualities that may render the rosin product inconsistent or incompatible with the musician’s particular preferences for application to the bow, durability, etc. Chemical fillers may also have adverse health impacts because, for example, after a rosin is applied and begins drying out on the bow—which is typical and the reason for regular rosining—chemical powders may be released and airborne, potentially causing health effects such as respiratory and eye irritation. Contemporary environmental considerations are another area of benefits for a rosin without chemical fillers.

For at least the above reasons and the perpetual desire from musicians to improve playability and performance qualities, improved rosin products, including complementary rosins, rosin formulations, and rosin systems for bowed string instruments would be beneficial. The exemplary embodiments in this disclosure address the need and desire for enhanced rosin products.

### BRIEF DESCRIPTION OF THE EXEMPLARY EMBODIMENTS

In an aspect, the exemplary embodiments include a rosin system for a stringed instrument bow. The rosin system may include a first rosin formulation including at least one base rosin and a second rosin formulation including at least one topcoat rosin. The first rosin formulation may be formulated for forming a rosin base coat layer adhered to a bow string when applied to the bow string. The second rosin formulation may be formulated for forming a rosin topcoat layer adhered to the rosin base coat layer when applied to the rosin base coat layer.

In another aspect, the exemplary embodiments include a rosin system for a bowed string instrument. The rosin system may include a first rosin cake formed from a first rosin composition including at least one base rosin and a second rosin cake formed from a second rosin composition including at least one topcoat rosin. The first rosin cake may be adapted for depositing a rosin base coat layer on a bow string when rubbed on the bow string and the second rosin cake may be adapted for depositing a rosin topcoat layer on the rosin base coat layer when rubbed on the rosin base coat layer.

In a further aspect, the exemplary embodiments include a method of applying a rosin system to an instrument bow. The method may include applying a first rosin formulation to the bow strings, the first rosin formulation may include at least one base rosin and be formulated for adhering to the bow strings and forming a rosin base coat layer on the bow strings. The method may further include applying a second rosin formulation to the rosin base coat layer, the second rosin formulation may include at least one topcoat rosin and be formulated for adhering to the rosin base coat layer and forming a rosin topcoat layer on the rosin base coat layer.

### BRIEF DESCRIPTION OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIG. 1 shows a rosin-coated bow for a stringed instrument according to an exemplary embodiment;

FIG. 2 is a flowchart of a method for preparing a rosin formulation according to an exemplary embodiment; and

FIG. 3 is a flowchart of a method for preparing a final rosin product according to an exemplary embodiment.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to aid in understanding the features of the exemplary embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

Reference will now be made in detail to various exemplary embodiments. Each example is provided by way of explanation and is not meant as a limitation and does not constitute a definition of all possible embodiments. It is understood that reference to a particular “exemplary embodiment” of, e.g., a structure, assembly, component, configuration, method, etc. includes exemplary embodiments of, e.g., the associated features, subcomponents, method steps, etc. forming a part of the “exemplary embodiment”.

For purposes of this disclosure, the phrases “devices,” “systems,” and “methods” may be used either individually or in any combination referring without limitation to disclosed components, grouping, arrangements, steps, functions, or processes.

According to an exemplary embodiment a rosin formulation for a bowed string instrument may include one or more of three different rosins from sources, i.e., trees, found in at least one of Georgia, Brazil, and South American sources other than Brazil (for purposes of this disclosure a “South American source” is understood to be a South American source different from Brazil, unless the disclosure says otherwise). In an exemplary embodiment, a first rosin, a second rosin, and a third rosin are pine rosins. In the same or other embodiments, the first rosin, second rosin, and third rosin are blended with a plasticizer. In an aspect, the plasticizer may be castor oil. In another aspect, one or more of the first rosin, the second rosin, and the third rosin may be blended with one or both of a plasticizer and a humectant.

With reference now to FIG. 1, according to various exemplary embodiments but without limitation thereto, a rosin-coated bow 100 includes a bow 101 for a stringed instrument (not shown), the bow 101 including a handle 102 and bow strings 103 as are known. The rosin-coated bow 100 includes a rosin base coat 110 deposited directly on the bow strings 103 and a rosin topcoat 120 deposited on top of the rosin base coat 110. The rosin base coat 110 is formed from a rosin base coat formulation for application directly the bow strings 103. According to an aspect, the rosin base coat 110 may have a two-rosin base coat formulation—i.e., a blend of two rosins—or a three-rosin base coat formulation formed from a blend of three rosins, a plasticizer, and a humectant.

The rosin topcoat 120 deposited on top of the rosin base coat 110 is formed from a rosin topcoat formulation. For purposes of this disclosure, it is understood that while “base coat” and “topcoat” such as rosin base coat 110 and rosin topcoat 120 refer to the rosin layers 110, 120 as deposited on the bow 101 according to the exemplary embodiments, the “rosin base coat formulation” and “rosin topcoat formulation” may refer generally to, e.g., the respective compositions and/or components of the of the base coat and topcoat whether as part of a manufacturing process or the deposited rosin base coat 110 and rosin topcoat 120 layers, as the specification makes clear.

An exemplary rosin topcoat formulation for application to the top of the rosin base coat 110 may be a blend of one rosin and a plasticizer. In an aspect, the layered rosin topcoat 120 and rosin base coat 110 create an exemplary rosin system 130 for the bow 101, including with respect to the corresponding rosin base coat formulation and rosin topcoat formulation.

In an aspect of the exemplary embodiments, the rosin base coat formulations have a relatively dark, warm and balanced color contributed by the component rosins. The rosin topcoat formulations have a relatively clear and bright color.

In an aspect, the rosin base coat formulation is configured (as discussed further below) for application as the rosin base coat 110 deposited directly on the bow strings 103 and is relatively soft and sticky which allows easier application directly to the bow strings 103 and better adherence to both the bow strings 103 and the rosin topcoat 120 according to the exemplary embodiments. The three-rosin base coat formulation is softer than the two-rosin base coat formulation according to the exemplary embodiments. A user may choose to apply one or more rosin base coat formulations such as the two-rosin and three-rosin base coat formulations as part of the rosin base coat 110 depending on the user’s preferences.

The rosin topcoat formulation is configured (as discussed further below) for application as the rosin topcoat 120 deposited on the rosin base coat 110, to form the rosin topcoat 120 and layered rosin system 130 according to the exemplary embodiments. The resulting two-part layered rosin system 130 including the rosin base coat 110 and the rosin topcoat 120 layers provides users with enhanced versatility to optimize their playing experience. The rosin topcoat layer 120 is relatively hard, clear, and more yellow similar to typical violin rosin. The rosin base coat 110 is darker and softer and in various embodiments resembles, e.g., maple syrup. The sensory properties of the rosin base coat formulation and the rosin topcoat formulation are recognizable and intuitive to users.

Embodiments of rosin systems such as layered rosin systems according to this disclosure are not limited to two-part rosin systems but may include, among other things, other layers as applications may dictate and consistent with this disclosure. The exemplary embodiments of a two-or-more-part rosin-coated bow system according to this disclosure contribute to more versatile performance by providing, e.g., improved conformance and adherence to the bow strings 103 via the soft and sticky rosin base coat 110 with the playability benefits of the hard, smooth rosin topcoat 120, thereby eliminating the need to sacrifice respective benefits by using only a single rosin.

In an aspect of this disclosure, exemplary rosin base coat formulations and rosin topcoat formulations of the two-part rosin system 130 share common or complementary components such as rosins, plasticizers, humectants, and/or other components consistent with this disclosure. Providing common or complementary components between exemplary rosin formulations used together improves compatibility of the rosin formulations with respect to, e.g., layerability and uniform feel of a single rosin product on the bow. In an aspect, common or complementary components may decrease adverse or inconsistent interactions between rosin formulations having different physical properties that may degrade performance. According to an aspect, the common or complementary components also include exemplary components such as plasticizers, emulsifiers, and other additives—consistent with this disclosure—to decrease counteractions that may occur between those components.

In an exemplary embodiment of a two-part rosin system according to this disclosure, a two-rosin base coat formulation includes first and second pine rosins, and a rosin topcoat formulation includes a third pine rosin and a plasticizer. According to an aspect, the first pine rosin is a Brazilian brown rosin and the second pine rosin and the third pine rosin are Georgian light-colored amber rosins. The exemplary two-rosin base coat formulation and rosin topcoat formulation provide the desirable performance and sensory properties discussed above.

Exemplary methods associated with forming and using the exemplary rosin formulations and systems, among other things, will now be introduced. The order and number of steps and aspects of individual steps according to the exemplary methods are not limiting, to the extent not inconsistent with this disclosure. For example, distinct steps may be performed in parallel where applicable for reducing the time required. In addition, exemplary temperatures, quantities, times, measurements, and the like are not meant as limitations and it is understood that other values or ranges may be effective for accomplishing the exemplary method(s), except where otherwise indicated. In addition, it is understood that certain steps related to particular components such as plasticizers and humectants (and additives generally) are not part of the exemplary methods for preparing rosin formulations that do not include the particular component(s).

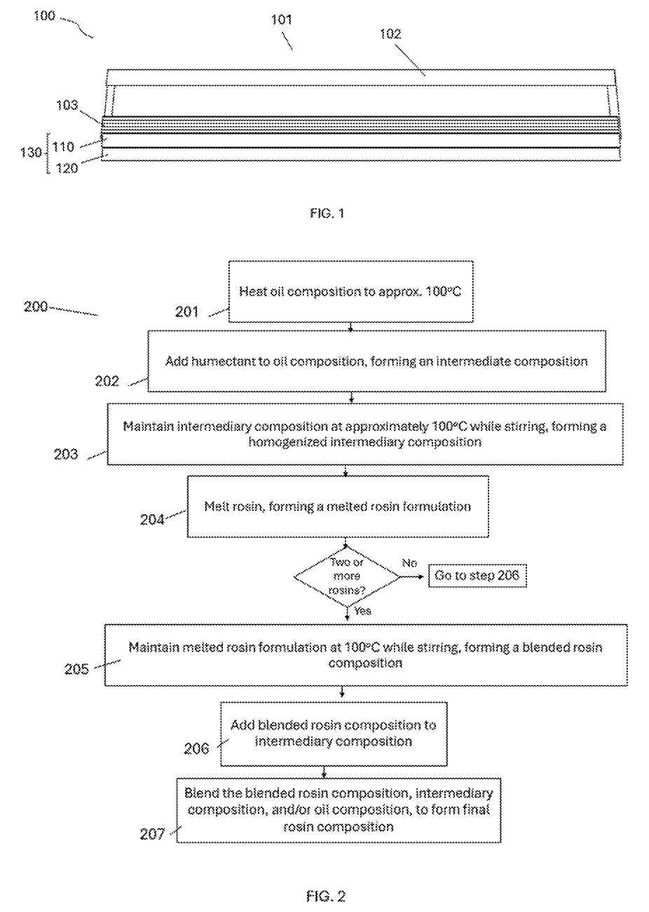

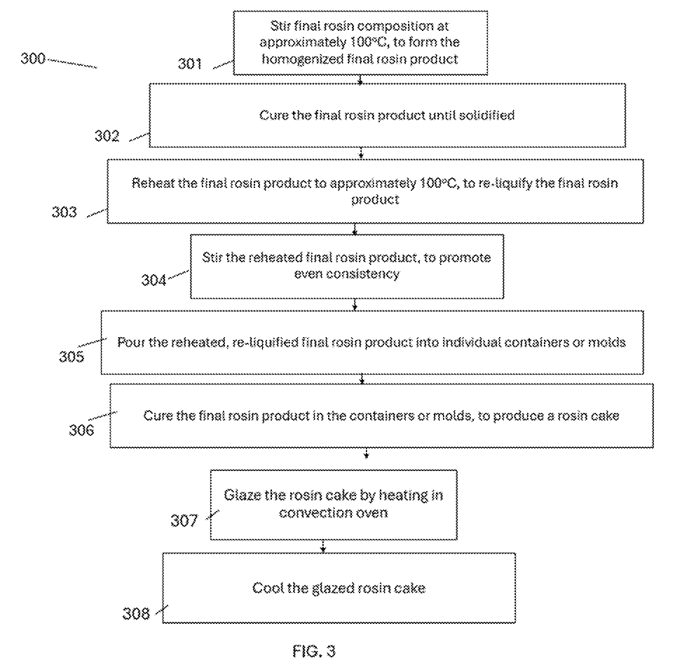

FIG. 2 illustrates an exemplary method 200 for preparing a rosin formulation such as a rosin base coat formulation or a rosin topcoat formulation according to the exemplary embodiments. For example, the exemplary method includes preparing an oil composition 201. In the exemplary method, preparing the oil composition includes heating approximately 40 ounces of the oil composition to a temperature of approximately 100° C (212° F). The oil composition may include one or more oils such as castor oil, linseed oil, olive oil, mineral oil, and the like. In other embodiments, sufficient quantity of the oil composition may be provided depending on the desired quantity of product. According to an aspect, the temperature should be high enough to promote homogenization of the oil composition as components are added according to further method steps, without denaturing the components. According to an aspect, the temperature should be maintained within a few degrees, e.g., between 97° C and 103° C, of 100° C. Generally, the oil composition serves as a plasticizer in the rosin formulation, for imparting softness and flexibility.

The exemplary methods may further include adding a humectant 202 (e.g., glycerin(s) such as vegetable glycerin, aloe vera, coco butter, and the like, including mixtures thereof) to the oil composition, once the oil composition has been heated to the approximately 100° C temperature, to form an intermediary composition including the oil composition and humectant. The humectant serves to maintain a moisture content of the rosin formulation, by balancing moisture retention. In the exemplary method, without limitation, approximately 2-6 liquid ounces of glycerin are used per 15 pounds of rosin in the rosin formulation according to the exemplary embodiments. The quantity of humectant generally is not so high as to create plasticizing effects from too much moisture content and not so low as to result in brittleness from too little moisture content. For example, the quantity of humectant is sufficient to ensure that the concentration of humectant is substantially maintained after heating steps of the exemplary methods, during which the humectant could potentially evaporate or become denatured. The concentration of humectant should substantially maintain a baseline moisture content—the baseline moisture content being the moisture content of the oil composition and/or intermediary composition—generally throughout the exemplary method(s). In an exemplary embodiment, approximately 4-6 liquid ounces of glycerin are used per 15 pounds of rosin in the exemplary rosin formulation(s).

The exemplary methods further include maintaining the intermediary composition temperature at approximately 100° C while stirring the intermediary composition, thereby forming a homogenized intermediary composition 203 in which the humectant and the oil composition components of the intermediary composition have uniformly distributed throughout the composition. In an aspect, the step of forming the homogenized intermediary composition includes maintaining the intermediary composition at 100° C for 30 minutes while stirring the intermediary composition every approximately 5 minutes, to achieve uniform distribution of the components.

The exemplary methods further include forming a melted rosin composition 204 containing one or more rosins. Forming the melted rosin composition includes, first, heating and thereby melting the one or more rosins. For example, melting two rosins if a two-rosin base coat is desired or three rosins if a three-rosin base coat is desired. Where a desired rosin formulation includes only one rosin—such as in the exemplary rosin topcoat formulation—the melting step includes melting the single rosin. For melted rosin compositions including two or more rosins, the rosins may be melted individually or together. If the rosins are melted individually, forming the melted rosin composition further includes combining the individual melted rosins to form the melted rosin composition.

The exemplary methods further include forming a blended rosin 205 from the melted rosin composition. Forming the blended rosin includes homogenizing the melted rosin composition by, e.g., heating and blending (by stirring or other known techniques) the melted rosin composition. In the exemplary method, the melted rosin composition is continuously stirred at a temperature of 100° C for approximately 30 minutes, or until homogenized, thereby forming the blended rosin which is the homogenized melted rosin composition. The blended rosin is effectively a distinct rosin with unique and consistent (due to the homogenization) characteristics and properties based at least in part on the properties of the melted rosin composition including the two or more rosins.

In an exemplary embodiment, for illustration and without limitation, forming a blended rosin 205 for a two-rosin base coat formulation includes forming a melted rosin composition 204 by melting a Brazilian brown rosin and a Georgia light-colored amber rosin. An exemplary method for forming a three-rosin base coat formulation includes forming a melted rosin composition 204 by melting a Brazilian brown rosin and a Georgia light-colored amber rosin, with an additional dark-colored or amber-colored rosin having a balanced and warm color. In an aspect, a rosin base coat formulation includes at least one dark- or warm-colored rosin to impart a dark or warm color to the rosin base coat formulation. Stringed instrument musicians may associate the dark or warm color with a soft and sticky rosin formulation that is readily applied and adhered to a bow.

In the same or other exemplary embodiments, forming a rosin topcoat formulation includes forming a melted rosin composition 204 by melting only a Georgian light-colored amber rosin or other yellow rosin having a light and bright color.

The exemplary methods include melting the rosins at a temperature of approximately 100° C (212° F). Maintaining/controlling the temperature while melting and/or blending the rosins or rosin composition promotes an evenly mixed composition such as the melted rosin composition and decreases potential degradation or other unfavorable results from overheating. Melted rosin compositions (and final rosin formulations/products discuss further below) have a particular color or hue, e.g., dark like maple syrup, amber like the sap of the same name, or relatively light and bright with a clear yellow tint. The color or hue is variable and depends on the rosin(s) used in the composition. Different rosins have different melting points but rosins generally, and according to the exemplary embodiments in this disclosure, begin softening at temperatures between about 75° C to 85° C while full liquefaction, without burning, is typically achieved at 100° C.

In further non-limiting aspects, yellow rosin varieties generally have a light and bright color and promote a clear, crisp musical tone. Dark rosins have a rich and dense musical tone and enhance grip between the bow and the instrument strings and contribute depth to the color tone of, e.g., a rosin base coat formulation. Amber-colored rosins contribute to balanced musical tone and warm color tone, each of which is somewhere between the musical and color tones of yellow rosins and dark rosins, and provide a versatile base rosin for forming blended rosins 205 incorporating other rosins.

The exemplary methods further include adding the blended rosin composition 206 to the intermediary composition. It is understood that the step of adding the blended rosin composition 206 includes adding the single melted rosin in the case of a single-rosin formulation. Further, in rosin formulations not including a plasticizer and/or humectant, for example, the blended rosin composition is added to whichever component the rosin formulation will include. For those rosin formulations in which a plasticizer or humectant is not included, the blended rosin composition (or individual rosin(s)) are not necessarily mixed with another component.

The oil composition or intermediary composition to which the blended rosin composition is added may include, e.g., known additives for achieving the desired properties of a rosin formulation consistent with this disclosure. Other embodiments may include adding a humectant only to the blended rosin/melted rosin composition. In an aspect of the exemplary methods in which the blended rosin composition is added to the oil composition or the intermediary composition, the blended rosin composition is added slowly, five pounds at a time, three times, while maintaining the 100° C temperature of the oil composition or intermediary composition and the blended rosin composition.

With continuing reference to FIG. 2, the exemplary methods further include blending the blended rosin composition and the oil composition or intermediary composition 207 by consistently stirring at approximately 100° C to promote proper emulsification of the oils and resins therein. The glycerin(s)—i.e., humectant—in, e.g., the intermediary composition, further act as a stabilizer, promoting desirable grip properties for the rosin formulation to grasp the bow and the instrument strings, via the moisture retention characteristics. The glycerin also aids in preventing the rosin formulation from drying out, thus promoting pliability. The resultant mixture including without limitation any or all desired rosins, oils (i.e., plasticizers), and humectants is, for purposes of this disclosure, the final rosin composition from which a final rosin product such as a rosin cake is formed, consistent with this disclosure. For purposes of this disclosure, a rosin formulation generally may refer to the final rosin composition or and/or composition in the final rosin product

With reference now to FIG. 3, an exemplary method 300 for forming a final rosin product includes stirring the final rosin composition 301 (without limitation) for about eight to 12 hours at a temperature of approximately 100° C to promote homogenization and produce a final rosin product, in the exemplary embodiment. The final rosin composition may be mixed—i.e., stirred—for other amounts of time sufficient to achieve the desired homogenization and thereby final rosin product constituting the homogenized final rosin composition.

The exemplary methods further include a first curing step 302 in which the final rosin product is cured by cooling the final rosin product. According to an aspect, the final rosin product is cured overnight, i.e., for a period of approximately eight to 12 hours. The final rosin product may be cured generally for an amount of time sufficient for the final rosin product to solidify as part of the curing process.

After the first curing step 302, the exemplary methods include heating the final rosin product 303 again to approximately 100° C, thereby liquifying the final rosin product, and maintaining the temperature while continuously stirring the reheated final rosin product 304 for another eight hours, according to an exemplary embodiment, to promote an even consistency.

The exemplary methods further include a pouring step 305 and a second curing step 306 for the reheated final rosin product. For example, the pouring step includes pouring the reheated final rosin product into individual containers or molds (not shown). The second curing step 306 includes cooling the reheated final rosin product within the containers or molds to room temperature, to produce a rosin cake. The pouring step 305 and second curing step 306 allow the reheated final rosin product to settle within the containers or molds and thereby promotes a smooth texture for the rosin cake before, e.g., further packaging or glazing steps for the rosin cake. The second curing step 306 includes cooling the reheated final rosin product and maintaining the resulting rosin cake at room temperature for about eight to 12 hours. However, the second curing step 306 in various embodiments may include maintaining the rosin cake at room temperature overnight or for a day or several days. The amount of time for the second curing step 306 should be sufficient to promote consistent stabilization between the respective rosin cakes within the individual containers or molds, thereby promoting consistent performance between rosin cakes.

The exemplary methods further include a glazing process 307 in which, in an aspect, the rosin cake is put into a commercial convection oven at a temperature about 425° F, for 2-3 minutes. In an aspect, the glazing process may heat the rosin cake sufficiently to promote a glossy finish and eliminate air bubbles, among other things. Following the glazing process 307, the rosin cake is cooled 308.

In an aspect, the exemplary methods 200, 300 promote consistent desired properties associated with applying the rosin to an instrument bow and resulting grip of the applied rosin during playing.

As discussed with respect to the exemplary embodiments of a rosin system 130 according to this disclosures, the exemplary method of applying the rosin system 130 to an instrument bow includes, for example, applying the rosin base coat on the bow strings 103. In the exemplary methods of applying the rosin system 130, reference to, e.g., the rosin base coat or rosin topcoat refers generally to the corresponding formulations 110, 120 discussed above and the rosin is applied from the rosin cakes (or other final rosin product consistent with this disclosure) derived respectively therefrom. In an aspect, approximately 3-6 swipes of the rosin base coat cake(s) are provided on the bow strings 103. The exemplary method of applying the rosin system 130 to an instrument bow further includes applying the rosin topcoat 120 layer to the rosin base coat 110 layer. In an aspect, approximately 1-2 swipes of the rosin topcoat cake(s) are provided on the rosin base coat 110. The rosin topcoat 120 layer adds a smoother section to the rosined bow, for solo work and generally enhancing or providing flexibility in the level of grip between the bow and the strings, depending on users’ preferences.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases "at least one", "one or more", and "and/or" are open-ended expressions that are both conjunctive and disjunctive in operation. For example, each of the expressions "at least one of A, B and C", "at least one of A, B, or C", "one or more of A, B, and C", "one or more of A, B, or C" and "A, B, and/or C" means A alone, B alone, C alone, A and B together, A and C together, B and C together, or A, B and C together.

Approximating language, as used herein throughout the specification and claims, may be applied to modify any quantitative representation that could permissibly vary without resulting in a change in the basic function to which it is related. Accordingly, a value modified by a term such as "about" or “approximately” is not to be limited to the precise value specified. Such approximating language may refer to the specific value and/or may include a range of values that may have the same impact or effect as understood by persons of ordinary skill in the art field. For example, approximating language may include a range of +/-10%, +/-5%, or +/-3%. The term “substantially” as used herein is used in the common way understood by persons of skill in the art field with regard to patents, and may in some instances function as approximating language. In some instances, the approximating language may correspond to the precision of an instrument for measuring the value.

In this specification and the claims that follow, reference will be made to a number of terms that have the following meanings. The terms "a" (or "an") and "the" refer to one or more of that entity, thereby including plural referents unless the context clearly dictates otherwise. As such, the terms "a" (or "an"), "one or more" and "at least one" can be used interchangeably herein. Furthermore, references to "one embodiment", "some embodiments", "an embodiment" and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as "about" is not to be limited to the precise value specified. In some instances, the approximating language may correspond to the precision of an instrument for measuring the value. Terms such as "first," "second," "upper," "lower" etc. are used to identify one element from another, and unless otherwise specified are not meant to refer to a particular order or number of elements.

As used herein, the terms "may" and "may be" indicate a possibility of an occurrence within a set of circumstances; a possession of a specified property, characteristic or function; and/or qualify another verb by expressing one or more of an ability, capability, or possibility associated with the qualified verb. Accordingly, usage of "may" and "may be" indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur - this distinction is captured by the terms "may" and "may be."

As used in the claims, the word "comprises" and its grammatical variants logically also subtend and include phrases of varying and differing extent such as for example, but not limited thereto, "consisting essentially of" and "consisting of." Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms "determine", "calculate" and "compute," and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

What is claimed is:

1. A rosin system for a stringed instrument bow, comprising:
a first rosin formulation, the first rosin formulation including at least one base rosin; and
a second rosin formulation, the second rosin formulation including at least one topcoat rosin, wherein the first rosin formulation is formulated for forming a rosin base coat layer adhered to a bow string when applied to the bow string and the second rosin formulation is formulated for forming a rosin topcoat layer adhered to the rosin base coat layer when applied to the rosin base coat layer.

2. The rosin system of claim 1, wherein one or both of the first rosin formulation and the second rosin formulation includes a plasticizer.

3. The rosin system of claim 2, wherein the plasticizer is castor oil.

4. The rosin system of claim 2, wherein the one or both of the first rosin formulation and the second rosin formulation includes a humectant.

5. The rosin system of claim 4, wherein the humectant is glycerin.

6. The rosin system of claim 1, wherein the at least one base rosin and the at least one topcoat rosin include a respective first pine rosin and a second pine rosin.

7. The rosin system of claim 1, wherein the first rosin formulation includes at least one brown rosin.

8. The rosin system of claim 7, wherein the second rosin formulation includes at least one of an amber rosin or a yellow rosin.

9. The rosin system of claim 8, wherein the first rosin formulation has a darker color than the second rosin formulation.

10. A rosin system for a bowed string instrument, comprising:
a first rosin cake, the first rosin cake formed from a first rosin composition including at least one base rosin; and
a second rosin cake, the second rosin cake formed from a second rosin composition including at least one topcoat rosin, wherein the first rosin cake is adapted for depositing a rosin base coat layer on a bow string when rubbed on the bow string and the second rosin cake is adapted for depositing a rosin topcoat layer on the rosin base coat layer when rubbed on the rosin base coat layer.

11. The rosin system of claim 10, wherein one or both of the first rosin composition and the second rosin composition includes a plasticizer.

12. The rosin system of claim 11, wherein the one or both of the first rosin composition and the second rosin composition includes a humectant.

13. The rosin system of claim 10, wherein the at least one base rosin and the at least one topcoat rosin include a respective first pine rosin and a second pine rosin.

14. The rosin system of claim 10, wherein the first rosin cake has a substantially brown color.

15. A method of applying a rosin system to an instrument bow, comprising:
applying a first rosin formulation to the bow strings, the first rosin formulation including at least one base rosin, wherein the first rosin formulation is formulated for adhering to the bow strings and forming a rosin base coat layer on the bow strings; and
applying a second rosin formulation to the rosin base coat layer, the second rosin formulation including at least one topcoat rosin, wherein the second rosin formulation is formulated for adhering to the rosin base coat layer and forming a rosin topcoat layer on the rosin base coat layer.

16. The method of claim 15, wherein applying the first rosin formulation to the bow strings includes rubbing a first rosin cake on the bow strings and applying the second rosin formulation to the rosin base coat layer includes rubbing a second rosin cake on the rosin base coat layer, wherein a respective composition of the first rosin cake and the second rosin cake includes the first rosin formulation and the second rosin formulation.

17. The method of claim 16, further comprising forming the respective first rosin formulation and the second rosin formulation, wherein forming the respective first rosin formulation and the second rosin formulation includes melting, separately, a base coat rosin to form a melted base coat rosin and a topcoat rosin to form a melted topcoat rosin; and
mixing, separately, one or both of the melted base coat rosin and the melted topcoat rosin with a plasticizer or a humectant.

18. The method of claim 17, wherein mixing the respective one or both of the melted base coat rosin and the melted topcoat rosin with the plasticizer or the humectant includes creating a respective first homogenous mixture and a second homogeneous mixture, wherein the first rosin formulation is formed from the first homogeneous mixture and the second rosin formulation is formed from the second homogeneous mixture.

19. The method of claim 17, further comprising forming the respective first rosin cake and the second rosin cake by curing the first homogeneous mixture and the second homogeneous mixture.

20. The method of claim 19, wherein curing the first homogeneous mixture and the second homogeneous mixture includes a first cooling step, a reheating step, and a second cooling step.
